(19) United States
(12) Patent Application Publication
(10) Pub. No.: US 2023/0178311 A1
(43) Pub. Date: Jun. 8, 2023

(54) KEY STRUCTURE

(71) Applicant: Primax Electronics Ltd., Taipei (TW)

(72) Inventors: Chuang-Shu Jhuang, Taipei (TW); Zhi-Hui Zeng, Taipei (TW); Jin Song, Taipei (TW)

(21) Appl. No.: 17/573,501

(22) Filed: Jan. 11, 2022

(30) Foreign Application Priority Data
Dec. 6, 2021 (CN) 202111477281.6

(51) Int. Cl. H01H 13/14

(52) U.S. Cl. CPC H01H 13/14; H01H 2233/07

(57) ABSTRACT

A key structure includes a base plate, a key pedestal, a switch element and a keycap. The key pedestal includes an opening and at least one elastic element. The keycap includes a triggering post and at least one contacting part. The key pedestal is installed on the base plate. The switch element is installed on the base plate and disposed within the opening of the key pedestal. The triggering post of the keycap is inserted into the opening of the key pedestal. The switch element can be triggered by the triggering post. The elastic element of the key pedestal is aligned with the corresponding contacting part. The contacting part of the keycap is continuously pushed against the corresponding elastic element of the key pedestal. Consequently, the keycap is maintained in a horizontal state and not tilted.

### FIELD OF THE INVENTION

The present invention relates to an input device, and more particularly to a key structure.

### BACKGROUND OF THE INVENTION

Generally, a key structure comprises a keycap, a support element and a signal trigger circuit. The keycap of the key structure can be ascended by the support element for a certain height. This height is related to a press stroke of the key structures. When the keycap is pressed by the user, the keycap is moved downwardly along the height, and thus the signal trigger circuit is trigged to generate a key signal. When the keycap is no longer pressed, the keycap is moved upwardly and returned to its original position along this height. Generally, the signal trigger circuit of the key structure is located under the center position of the keycap. In other words, the junction between the keycap and the support element is close to the center position of the keycap in order to facilitate supporting and returning the pressed keycap.

However, the conventional key structure still has some drawbacks. For example, when the keycap is ascended to the height, the regions under the edges and corners of the keycap are hollow regions. Moreover, since the edges and corners of the keycap are not connected with and the supported by the support element, the edges and corners of the keycap are prone to the instable rocking condition. If the keycap is pressed frequently, the keycap is readily tilted. Since the force-exerted area of the keycap is shifted, the keycap is possibly damaged, and the press sensitivity of the keycap is possibly deteriorated.

### SUMMARY OF THE INVENTION

For solving the drawbacks of the conventional technologies, the present invention provides a key structure. The key structure is equipped with a key pedestal. The key pedestal is equipped with an elastic element. The elastic element is aligned with an edge or a corner of the keycap. Regardless of whether the keycap is pressed, the elastic element is continuously pushed against the keycap to elastically support the keycap. Due to this structural design, the hollow space under the edge or the corner of the keycap is largely reduced, and the height of the press stroke is maintained. Consequently, the keycap can be maintained in the horizontal state and not tilted, and the keycap can be stabilized and not rocked. Moreover, the press sensitivity of the keycap is enhanced.

In accordance with an aspect of the present invention, a key structure is provided. The key structure includes a base plate, a key pedestal, a switch element and a keycap. The key pedestal is installed on the base plate. The key pedestal includes an opening, a first hook and at least one elastic element. The first hook and the at least one elastic element are located at a periphery of the opening. The switch element is installed on the base plate and disposed within the opening of the key pedestal. The keycap is installed on the key pedestal. The key pedestal is covered by the keycap. The keycap includes a triggering post, a second hook and at least one contacting part. The triggering post and the second hook are inserted into the opening of the key pedestal. The triggering post is aligned with the switch element. The second hook is aligned with the first hook of the key pedestal, each contacting part is installed on a peripheral area of the keycap. Each contacting part is aligned and contacted with the corresponding elastic element of the key pedestal. Each contacting part of the keycap is continuously pushed against the corresponding elastic element of the key pedestal. Consequently, the keycap is maintained in a horizontal state and not tilted.

In an embodiment, a bottom surface of the keycap is aligned with the key pedestal, and the key pedestal is covered by the bottom surface. The triggering post, the second hook and the at least one contacting part of the keycap are protruded from the bottom surface of the keycap in a direction toward the key pedestal.

In an embodiment, the first hook of the key pedestal is located at the periphery of the opening and extended in a direction toward the opening, and the second hook of the keycap is inserted into the opening of the key pedestal and extended in a direction toward the first hook. The first hook and the second hook are engaged with each other.

In an embodiment, the keycap has an edge part. The edge part is located at the peripheral area of the keycap. The contacting part is installed on the edge part of the keycap. The elastic element of the key pedestal is aligned with the edge part of the keycap.

In an embodiment, the keycap has a center part. The triggering post and the second hook are installed on the center part of the keycap, and the opening of the key pedestal is aligned with the center part of the keycap.

In an embodiment, the second hook of the keycap is arranged around the triggering post, and the first hook and the at least one elastic element of the key pedestal are arranged around the opening.

In an embodiment, each elastic element of the key pedestal comprises a protrusion part. The protrusion part is extended in a direction toward the keycap. The protrusion part is pushed against the corresponding contacting part of the keycap.

In an embodiment, the at least one elastic element of the key pedestal is elastically deformable, and the at least one elastic element is continuously pushed against the corresponding contacting part. Consequently, the keycap is maintained in the horizontal state.

In an embodiment, the key pedestal further includes a positioning post, and the keycap further includes a positioning recess. The positioning post is inserted into the positioning recess.

In an embodiment, the keycap further includes a position-limiting structure. The position-limiting structure is located beside the second hook of the keycap. The position-limiting structure is inserted into the opening of the key pedestal.

In an embodiment, the key pedestal further comprises a locking post, and the locking post is locked in the positioning plate. Consequently, the key pedestal is fixed on the base plate.

In an embodiment, the elastic element of the key pedestal is a resilience arm.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a key structure according to an embodiment of the present invention;

FIG. 2 is a schematic exploded view illustrating the key structure as shown in FIG. 1;

FIG. 3 is a schematic perspective view illustrating the relationship between the keycap and the key pedestal of the key structure according to the embodiment of the present invention;

FIG. 4 is a schematic cross-sectional view illustrating the key structure according to the embodiment of the present invention; and

FIG. 5 is a schematic cross-sectional view illustrating the key structure according to the embodiment of the present invention and taken along another viewpoint.

### DETAILED DESCRIPTION OF THE PREFERRED EMBODIMENT

The present invention will now be described more specifically with reference to the following embodiments and accompanying drawings.

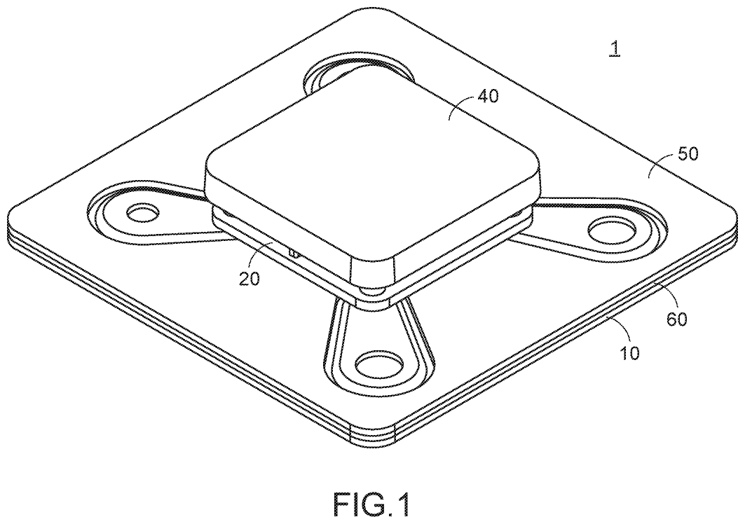

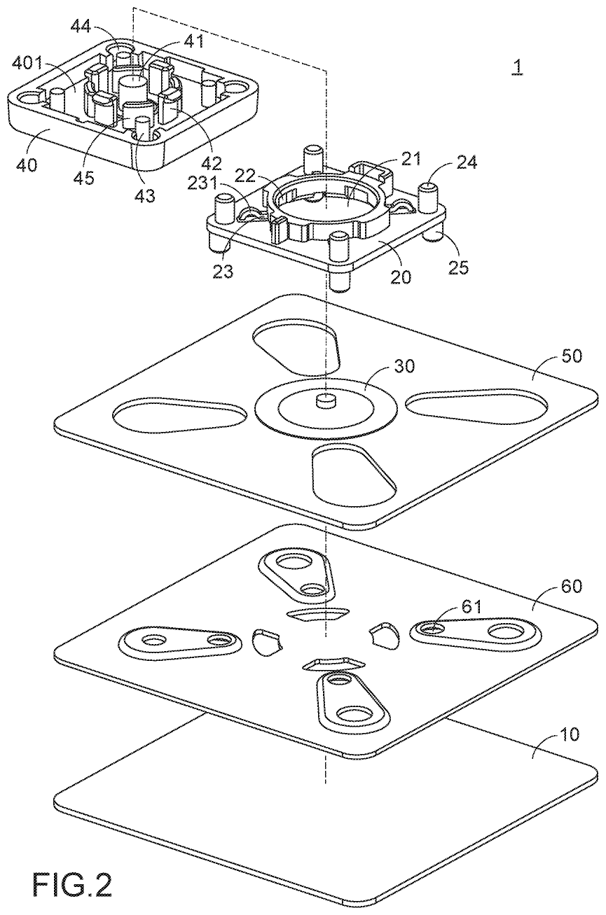

FIG. 1 is a schematic perspective view illustrating a key structure according to an embodiment of the present invention. FIG. 2 is a schematic exploded view illustrating the key structure as shown in FIG. 1. As shown in FIGS. 1 and 2, the key structure 1 comprises a base plate 10, a key pedestal 20, a switch element 30, a keycap 40, a circuit layer 50 and a positioning plate 60.

The key pedestal 20 comprises an opening 21, at least one first hook 22 and at least one elastic element 23. The keycap 40 comprises a triggering post 41, at least one second hook 42 and at least one contacting part 43. In an embodiment, the key pedestal 20 comprises the opening 21, four first hooks 22 and four elastic elements 23, and the keycap 40 comprises the triggering post 41, four second hooks 42 and four contacting parts 43.

The positioning plate 60 and the circuit layer 50 are installed on the base plate 10. The key pedestal 20 is fixed on the base plate 10 and located over the circuit layer 50. The switch element 30 is installed on the base plate 10 and electrically connected with the circuit layer 50. In addition, the switch element 30 is disposed within the opening 21 of the key pedestal 20. The keycap 40 is installed on the key pedestal 20. In addition, the switch element 30 is covered by the keycap 40. The triggering post 41 and the second hooks 42 of the keycap 40 are inserted into the opening 21 of the key pedestal 20. The triggering post 41 of the keycap 40 is aligned with the switch element 30. The second hooks 42 of the keycap 40 are aligned with the corresponding first hooks 22 of the key pedestal 20. The contacting parts 43 of the keycap 40 are aligned and contacted with the corresponding elastic elements 23 of the key pedestal 20.

In accordance with a feature of the present invention, the contacting parts 43 of the keycap 40 are continuously pushed against the corresponding elastic elements 23 of the key pedestal 20. Consequently, there is no vacant space in the contact area between each contacting part 43 and the corresponding elastic element 23. Since the keycap 40 is effectively supported, the keycap 40 on the key pedestal 20 can be maintained in the horizontal state without being tilted or rocked.

Please refer to FIG. 2 again. The keycap 40 has a bottom surface 401. The bottom surface 401 of the keycap 40 is aligned with the key pedestal 20, and the key pedestal 20 is covered by the bottom surface 401 of the keycap 40. In addition, the opening 21 of the key pedestal 20 is also covered by the bottom surface 401 of the keycap 40. The triggering post 41, the second hooks 42 and the contacting parts 43 of the keycap 40 are all protruded from the bottom surface 401 of the keycap 40 in the direction toward the key pedestal 20. The first hooks 22 and the elastic elements 23 of the key pedestal 20 are located at the periphery of the opening 21 of the key pedestal 20. The switch element 30 is disposed within the opening 21 of the key pedestal 20.

When the keycap 40 is assembled with the key pedestal 20, the triggering post 41 and the second hooks 42 of the keycap 40 are inserted into the opening 21 of the key pedestal 20. The triggering post 41 is aligned with the switch element 30. When the switch element 30 is triggered by the triggering post 41, the switch element 30 generates a key signal. The second hooks 42 of the keycap 40 are aligned with the corresponding first hooks 22 of the key pedestal 20. Moreover, the second hooks 42 and the corresponding first hooks 22 are movably engaged with each other. Consequently, the keycap 40 is positioned on the key pedestal 20, and the keycap 40 is movable upwardly or downwardly relative to the key pedestal 20 after the keycap 40 is pressed down by the user. After the keycap 40 is assembled with the key pedestal 20, the contacting parts 43 of the keycap 40 are contacted with and pushed against the corresponding elastic elements 23 of the key pedestal 20. Consequently, the hollow space under the keycap 40 is reduced. Since the keycap 40 is supported by the elastic elements 23, the efficacy of stabilizing the keycap 40 is enhanced.

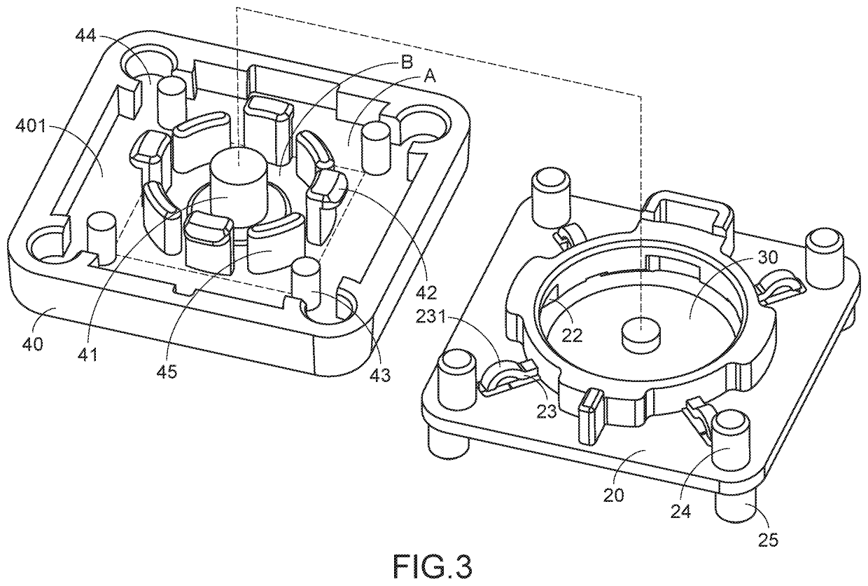

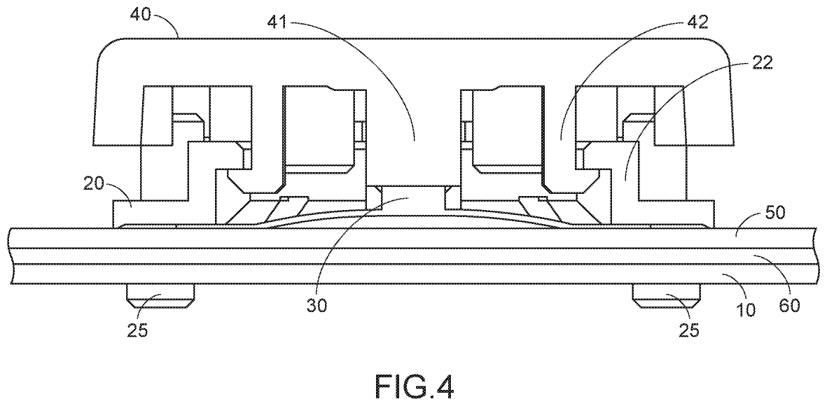

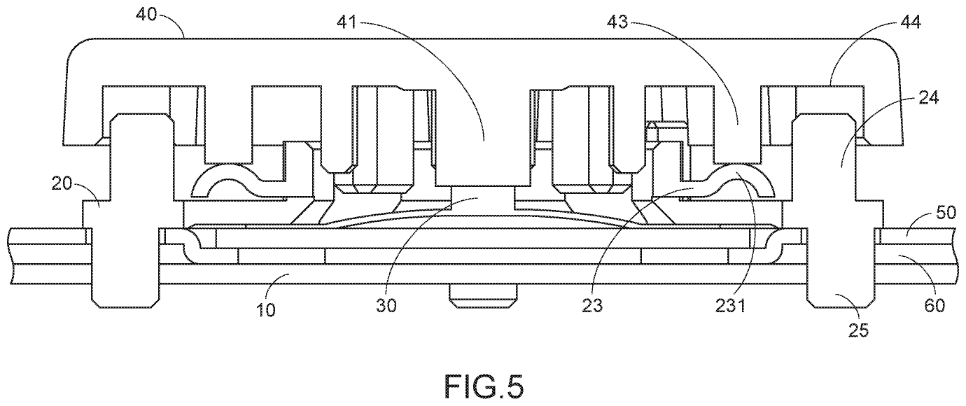

The detailed structure of the keycap 40, the detailed structure of the key pedestal 20 and the combined structure of the keycap 40 and the key pedestal 20 will be described as follows. FIG. 3 is a schematic perspective view illustrating the relationship between the keycap and the key pedestal of the key structure according to the embodiment of the present invention. FIG. 4 is a schematic cross-sectional view illustrating the key structure according to the embodiment of the present invention. FIG. 5 is a schematic cross-sectional view illustrating the key structure according to the embodiment of the present invention and taken along another viewpoint.

The keycap 40 comprises an edge part A, a center part B and a position-limiting structure 45. Moreover, each elastic element 23 of the key pedestal 20 comprises a protrusion part 231. The edge part A of the keycap 40 is located at a peripheral area of the keycap 40. As shown in FIG. 3, the edge part A includes the four corner regions of the rectangular keycap 40, or the edge part A includes the edge regions of the keycap 40. The center part B of the keycap 40 is located at the geometric center region of the keycap 40. As shown in FIG. 3, the center part B is located at the center region of the rectangular keycap 40, or the center part B is aligned with the plane center of the bottom surface 401 of the keycap 40. The contacting parts 43 of the keycap 40 are installed on the edge part A of the keycap 40. The elastic elements 23 of the key pedestal 20 are aligned with the edge part A of the keycap 40. The triggering post 41 and the second hooks 42 of the keycap 40 are installed on the center part B of the keycap 40. Moreover, the opening 21 of the key pedestal 20 is aligned with the center part B of the keycap 40.

The position-limiting structure 45 is installed on the bottom surface 401 of the keycap 40 and extended in the direction toward the key pedestal 20. The position-limiting structure 45 is located beside the second hooks 42. When the keycap 40 is assembled with the key pedestal 20, all of the triggering post 41, the second hooks 42 and the contacting parts 43 of the keycap 40 are inserted into the opening 21 of the key pedestal 20. After the triggering post 41 and the second hooks 42 are inserted into the opening 21 of the key pedestal 20, the positions of the triggering post 41 and the second hooks 42 can be limited in the opening 21 by the position-limiting structure 45. Due to the arrangement of the position-limiting structure 45, the keycap 40 is not shifted. Consequently, the second hooks 42 are not detached from the first hooks 22. Moreover, due to the arrangement of the position-limiting structure 45, the triggering post 41 is not too askew to trigger the switch element 30.

The first hooks 22 and the elastic elements 23 of the key pedestal 20 are arranged around the opening 21 of the key pedestal 20. Preferably, the first hooks 22 are located at the periphery of the opening 21 and extended in the direction toward the opening 21. The second hooks 42 of the keycap 40 is arranged around the triggering post 41 of the keycap 40. Moreover, the second hooks 42 of the keycap 40 are inserted into the opening 21 of the key pedestal 20 and extended in the direction toward the corresponding first hooks 22. Consequently, the first hooks 22 and the corresponding second hooks 42 are engaged with each other.

The protrusion part 231 of each elastic element 23 of the key pedestal 20 is extended in the direction toward the bottom surface 401 of the keycap 40. In addition, the protrusion part 231 is pushed against the corresponding contacting part 43 of the keycap 40. That is, the contacting part 43 of the keycap 40 is pushed against and contacted with the protrusion part 231 of the elastic element 23. The elastic element 23 is elastically deformable. Consequently, when the contacting part 43 is pushed against and contacted with the protrusion part 231 of the corresponding elastic element 23, the elastic element 23 continuously provides an elastic force. In response to the elastic force, the protrusion part 231 is continuously pushed against the corresponding contacting part 43. Consequently, there is no vacant space in the contact area between the contacting part 43 and the corresponding elastic element 23. Since the regions under the four corner regions or the edge regions of the rectangular keycap 40 are supported, the keycap 30 can be maintained in the horizontal state without being tilted or rocked.

In an embodiment, the key pedestal 20 further comprises at least one positioning post 24 and at least one locking post 25. In addition, the keycap 40 comprises at least one positioning recess 44. The positioning plate 60 comprises at least one locking hole 61. The positioning post 24 of the key pedestal 20 is inserted into the corresponding positioning recess 44 of the keycap 40. Consequently, while the keycap 40 is installed on the key pedestal 20, the engagement between the positioning post 24 and positioning recess 44 can facilitate positioning the keycap 40 on the key pedestal 20 and assembling the keycap 40 with the key pedestal 20. Moreover, the engagement between the positioning post 24 and positioning recess 44 can assist the key pedestal 20 in supporting the keycap 40. The locking post 25 of the key pedestal 20 is locked into the corresponding locking hole 61 of the positioning plate 60. Consequently, the key pedestal 20 can be securely fixed on the base plate 10.

Preferably but not exclusively, the elastic element 23 of the key pedestal 20 is a resilience arm, a plunger spring or an elastic pad.

In the above embodiment, the key structure is equipped with plural elastic elements and plural contacting parts to achieve the purpose of stabilizing the keycap. It is noted that the concepts of the present invention can be applied to the key structure with a single elastic element and a single contacting part. For example, in a variant example, each of the single elastic element and the single contacting part have ring-shaped profiles (e.g., circular ring structures or rectangular ring structures). The ring-shaped elastic element is arranged around the opening of the key pedestal. The ring-shaped contacting part is installed on the peripheral area of the keycap. Moreover, the ring-shaped elastic element and the ring-shaped contacting part are continuously pushed against each other.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

1. A key structure, comprising:
a base plate;
a key pedestal installed on the base plate, and comprising an opening, a first hook and at least one elastic element, wherein the first hook and the at least one elastic element are located at a periphery of the opening;
a switch element installed on the base plate and disposed within the opening of the key pedestal; and
a keycap installed on the key pedestal, wherein the key pedestal is covered by the keycap, and the keycap comprises a triggering post, a second hook and at least one contacting part, wherein the triggering post and the second hook are inserted into the opening of the key pedestal, the triggering post is aligned with the switch element, the second hook is aligned with the first hook of the key pedestal, each contacting part is installed on a peripheral area of the keycap, and each contacting part is aligned and contacted with a corresponding elastic element of the key pedestal,
wherein each contacting part of the keycap engages the corresponding elastic element of the key pedestal, so that the keycap is maintained in a horizontal state and not tilted.

2. The key structure according to claim 1, wherein a bottom surface of the keycap is aligned with the key pedestal, and the key pedestal is covered by the bottom surface, wherein the triggering post, the second hook and the at least one contacting part of the keycap are protruded from the bottom surface of the keycap in a direction toward the key pedestal.

3. The key structure according to claim 1, wherein the first hook of the key pedestal is located at the periphery of the opening and extended in a direction toward the opening, and the second hook of the keycap is inserted into the opening of the key pedestal and extended in a direction toward the first hook, wherein the first hook and the second hook are engaged with each other.

4. The key structure according to claim 1, wherein the keycap has an edge part, wherein the edge part is located at the peripheral area of the keycap, the at least one contacting part is installed on the edge part of the keycap, and the at least one elastic element of the key pedestal is aligned with the edge part of the keycap.

5. The key structure according to claim 1, wherein the keycap has a center part, wherein the triggering post and the second hook are installed on the center part of the keycap, and the opening of the key pedestal is aligned with the center part of the keycap.

6. The key structure according to claim 1, wherein the second hook of the keycap is arranged around the triggering post, and the first hook and the at least one elastic element of the key pedestal are arranged around the opening.

7. The key structure according to claim 1, wherein each of the at least one elastic elements of the key pedestal comprises a protrusion part, wherein the protrusion part is extended in a direction toward the keycap, and the protrusion part is pushed against a corresponding contacting part of the keycap.

8. The key structure according to claim 1, wherein the at least one elastic element of the key pedestal is elastically deformable, and the at least one elastic element engages the corresponding contacting part, so that the keycap is maintained in the horizontal state.

9. The key structure according to claim 1, wherein the key pedestal further comprises a positioning post, and the keycap further comprises a positioning recess, wherein the positioning post is inserted into the positioning recess.

10. The key structure according to claim 1, wherein the keycap further comprises a position-limiting structure, wherein the position-limiting structure is located beside the second hook of the keycap, and the position-limiting structure is inserted into the opening of the key pedestal.

11. The key structure according to claim 1, wherein the key pedestal further comprises a locking post, and the locking post is locked in the positioning plate, so that the key pedestal is fixed on the base plate.

12. The key structure according to claim 1, wherein the at least one elastic element of the key pedestal is a resilience arm.
